(19) United States
(12) Patent Application Publication
(10) Pub. No.: US 2014/0345572 A1
(43) Pub. Date: Nov. 27, 2014

(54) RECIPROCATING INTERNAL COMBUSTION ENGINE

(71) Applicants: Pao Chi Pien, Chevy Chase, MD (US); Paul Shih-Hsi Pien, Bethesda, MD (US)

(72) Inventors: Pao Chi Pien, Chevy Chase, MD (US); Paul Shih-Hsi Pien, Bethesda, MD (US)

(21) Appl. No.: 14/452,379

(22) Filed: Aug. 5, 2014

Related U.S. Application Data
(63) Continuation-in-part of application No. 13/855,660, filed on Apr. 2, 2013, now Pat. No. 8,826,868.
(60) Provisional application No. 61/619,205, filed on Apr. 2, 2012.
(60) Provisional application No. 61/683,781, filed on Aug. 16, 2012.

(51) Int. Cl. F02B 75/04

(52) U.S. Cl. CPC F02B 75/04
USPC 123/48 R; 701/101; 29/888.011

(57) ABSTRACT

A method for determining a heat addition needed to achieve a target/limiting combustion temperature of a working fluid in a thermodynamic cycle in an engine can include determining a third state of the thermodynamic cycle, where the third state is defined by a third internal energy E_{3Qless} and a third volume V₃ of the working fluid located in a cylinder of the engine, where an equation of state E_{3Qless}/E₂=(V₂/V₃)^{k-1} is used to solve for E_{3Qless} when E₁, V₁, E₂, and V₂ are known. The method can include determining a target/limiting internal energy E_{3Limiting} that corresponds to a selected target/limiting combustion temperature T₃ at the third state by solving E_{3Limiting}=cᵥT₃. The heat addition Q needed to reach the target/limiting internal energy E_{3Limiting} at the third state can then be determined by solving Q=E_{3Limiting}−E_{3Qless}.

### CROSS-REFERENCE TO RELATED APPLICATIONS

This application is a continuation-in-part of U.S. patent application Ser. No. 13/855,660, filed Apr. 2, 2013, which claims the benefit of U.S. Provisional Patent Application Nos. 61/619,205, filed Apr. 2, 2012, and 61/683,781, filed Aug. 16, 2012, all of which are hereby incorporated by reference in their entirety.

### FIELD

The present application relates to reciprocating internal combustion engines. More specifically, the present application relates to reciprocating internal combustion engines capable of operating at high efficiencies while producing very low emissions.

### DETAILED DESCRIPTION

The reciprocating internal combustion engine (“RICE”) is a simple device that transforms energy from one form to another consistent with the first law of thermodynamics, expressed as “pV=mRT” for an ideal gas, where p is the pressure of a working fluid, V is volume occupied by the working fluid, m is mass of the working fluid, R is the gas constant, and T is temperature of the working fluid. When the temperature “T” distribution of the working fluid is multiplied by specific heat at constant volume “cᵥ,” an internal energy distribution “E(cᵥT)” is obtained. When the first law of thermodynamics is expressed in terms of internal energy “E,” both total volume “V” and total internal energy “E” contained within the total volume become state variables. An equation of state that expresses the relationship between state variables E and V can be derived.

This new equation of state facilitates the creation of a new method for controlling combustion temperatures in a RICE by allowing the internal energy at any point in the combustion process to be readily calculated. In turn, by allowing the internal energy E at any point in a combustion process to be calculated, the new method calculates internal energy E produced by the compression process together with the amount of heat addition Q required to meet/satisfy “E” design goals/requirements.

This equation of state facilitates the creation of a new dual-step combustion process (DSCP). The creation of the new DSCP in turn further facilitates the development of a unique compression-ignition reciprocating internal combustion engine to operate on the new DSCP. This newly developed CI-DSCP RICE has the potential to reduce significantly specific fuel consumption and greenhouse gases.

The concepts described herein and defined by the enumerated claims may be better understood by referring to the following description. The descriptions of certain embodiments are set out below to enable one to build and use implementations of the invention, and are not intended to limit the enumerated claims, but rather to serve as particular examples thereof. Those skilled in the art should appreciate that they may readily use the conception and specific embodiments disclosed as a basis for modifying or designing other methods and systems for carrying out the same purposes. Those skilled in the art should also realize that such equivalent assemblies do not depart from the spirit and scope of the invention in its broadest form.

The Derivation of the Equation of State “E₂/E₁=(V₁/V₂)^{k-1}”

The first law of thermodynamics pV=mRT is converted into an equation of state, which is employed to compute the transformation of energy from one form to another for all thermodynamic processes of a reciprocating internal combustion engine. Taking the ratio between p₁V₁=mR₁T and p₂V₂=mR₂T eliminates “mR” leaving “(p₁V₁/T₁)/(p₂V₂/T₂)” a dimensionless constant. Since p₁/p₂=(V₂/V₁)^{k}, (p₁V₁/T₁)/(p₂V₂/T₂) is equal to T₂/T₁=(V₁/V₂)^{k-1}, then, (T₁/cᵥ)/(T₂/cᵥ)=(V₁/V₂)^{k-1} becomes E₂/E₁=(V₁/V₂)^{k-1}, which is an equation of state that expresses the relationship between the two state variables E and V of a gas. Based on Dalton's partial pressure law, E₂/E₁=(V₁/V₂)^{k-1} can be applied to a mixed gas with “k” taken as the weighted average of the k values of all of the component gases.

The equation of state E₂/E₁=(V₁/V₂)^{k-1} can be applied to any element of the volume of cylinder gas without involving mass “m.” Instead of defining a state by a numerical number, a state can be defined by two state variables E and V. In doing so, the equation of state E₂/E₁=(V₁/V₂)^{k-1} gives the change in E₁ to E₂ due to the change in V₁ to V₂ (i.e., that energy transformation between work done W and working fluid internal energy E without heat addition) and vice versa. When heat addition takes place simultaneously with the volume change, the total change in E is shown by the change from E₂ to E₃.

Thus, for any RICE, this equation of state can be used to compute the second state (E₂, V₂) from a given initial state (E₁, V₁) located on an E-V plane. More specifically, E₂=E₁(V₁/V₂)^{k-1} or V₂=V₁(E₂/E₁)^{1/(k-1)} (satisfying the conservation of energy law). When heat addition Q takes place simultaneously with the volume change, the total internal energy E₃ is given by E₂+Q. An expansion process 3-4 reduces E₃ to E₄ with E₄=E₃(V₃/V₄)^{k-1}. At the end of expansion process 3-4, E₄ is rejected from the cylinder through the open exhaust valve.

The ability to compute the transformation of internal energy from one form to another in a RICE, greatly simplifies the task of understanding and describing the thermodynamic processes of a RICE. In addition, by allowing “E” to be readily calculated for a given state, the derivation/development of the equation of state E₂/E₁=(V₁,V₂)^{k-1} allows indicated fuel conversion efficiency (IFCE) to be calculated/expressed in terms of internal energy balance. More specifically, IFCE=1−F₄/E₃. These two equations, E₂/E₁=(V₁,V₂)^{k-1} and IFCE=1−E₄/E₃ provide essential tools based on the first law of thermodynamics that facilitate the evaluation of existing RICEs, as well as, allow new RICE designs to be readily evaluated. It is worthwhile noting that because the velocity of a piston and the velocity of the cylinder gas are both many orders smaller than the velocity of cylinder gas molecules the equation of state E₂/E₁=(V₁,V₂)^{k-1} can be used to compute change in E from the change in V and vice versa of a mixed gas.

A Method for Controlling Combustion Temperatures in a RICE

As previously stated, the equation of state E₂/E₁=(V₁,V₂)^{k-1} allows the “E” at any given state (as defined by a given E and a corresponding V) to be readily calculated. Moreover, since E=cᵥT, or T=E/cᵥ, the combustion temperature at any given state can also be readily calculated. Thus, by allowing the combustion temperature to be calculated at any point during the combustion process, the equation of state provides the wherewithal to calculate the amount of Q required for meeting design requirement including limitations on combustion temperature.

The usefulness of the state E₂/E₁=(V₁,V₂)^{k-1} in simplifying the understanding and evaluation of a RICE is illustrated by appreciating that in a RICE the working fluid internal energy E can be (and is) increased by both work W done on the system and heat addition Q to the system, simultaneously. For example, heat addition Q can begin at state (E₂, V₂) before the piston reaches TDC with V₂=0.975 ft³ and E₂=E₁(V₁/V₂)^{0.4}=95.73(15.6/0.867)^{0.4}=290.2 Btu. To reach state (650 Btu, 0.867 ft³) from state (290.2 Btu, 0.975), 359.8 Btu (650−290.2) must be added regardless what portion of the required 359.8 Btu is contributed by work done “W” on the system and what portion is contributed by heat addition “Q.” For any particular case, the proportion of work done and heat addition depends upon many factors such as fuel injection system, combustion chamber geometry, engine rpm and loading, etc. Only internal energy balance (IFCE=1−E₄/E₃) can account for both work done W and heat addition Q, while work done W or heat addition Q balance can only account for one or the other, but not both.

A New CI-DSCP RICE Operating on a Newly Created Dual-Step Combustion Process

To achieve the twin goals of producing a highly efficient and clean burning internal combustion engine (i.e. with low engine out emissions), a new dual-step combustion process (“DSCP”) has been created. The first step combustion process is similar to a constant-volume (“CV”) combustion process, but differs in recognizing that CV combustion is not attainable in a real engine. The primary difference between the first-step combustion process (from a CV combustion process) is that heat addition occurs prior to top dead center to facilitate a longer combustion process to ensure complete mixing and burning. The first-step combustion process is followed by a second-step constant-internal energy (CE) combustion process. The first combustion step allows a high compression (and in turn high expansion) ratio to be utilized. The purpose of the second-step CE combustion process is to provide an additional combustion process to meet the full range of loading requirements while ensuring that the combustion temperature at the end of the first-step combustion process and the ensuing second step CE combustion process do not exceed the threshold combustion temperature at which NOx formation occurs.

A new compression-ignition dual step combustion process (CI-DSCP) RICE is developed based on the new dual step combustion process. The new engine is sized so that the first step combustion process meets a given design performance specification and the second-step CE combustion process allows the engine to meet performance requirements not met by the first-step combustion process. This engine sizing approach allows significant potential engine down-sizing. As set forth below, the new CI-DSC RICE will achieve the twin goals of high efficiency with minimal engine-out emissions.

The First-Step Combustion Process

For the first part of the DSCP process, the first-step combustion process is designed to meet specified operating/performance criteria subject to the limitation/condition that at the end of the first-step combustion process the combustion temperature is below the threshold temperature at which NOx formation takes place. For instance, the design parameter could be for the engine operating on the first-step combustion process alone to provide sufficient power for cruising at highway speeds. As previously mentioned and as discussed more fully below, the second part of the DSCP process, the second-step CE process will be available to meet performance requirements exceeding the performance capabilities of the first-step combustion process (as designed).

It should be noted that as discussed above, the equation of state E₂/E₁=(V₁,V₂)^{k-1} allows the “E” at any given state to be readily calculated. Further, since E=cᵥT, or T=E/cᵥ, the temperature at any given state (as defined by E and V) can also be readily calculated. Whereas, since T is not a state variable, it would be impracticable to attempt to accurately compute without the equation of state E₂/E₁=(V₁,V₂)^{k-1}.

For purposes of this discussion and by way of example, assume that the beginning of a compression process 1-2, V₁=15.6 ft³, p₁=14.7 psia, T₁=311° K, E₁=eᵥT₁=95.73 Btu. The equation of state E₂/E₁=(V₁,V₂)^{k-1} allows any given “state” at any point of the cycle to be defined by values of E and V allowing a particular state to be easily located on an E-V plane. Moreover, the equation of state E₂/E₁=(V₁,V₂)^{k-1} is used to compute E₂ from a given V₂ or vice versa, always satisfying the conservation of energy law. For example, for a given compression ratio of 16.0, assume that the first-step combustion process (i.e., heat addition Q) occurs at the state (290.2 Btu, 0.975 ft³). Further assume that the design requirement of the first-step combustion process is to limit combustion temperatures of the first-step combustion process to less than 2112° K, the critical temperature at which NOx formation takes place. A maximum of 359.8 (650−290.2) Btu can be added to reach the state (650 Btu, 0.867 ft³) (at which combustion temperature will be 2112° K) regardless what portion of the required 359.8 Btu is contributed by work done “W” and what portion is contributed by heat addition “Q.” An expansion process 3-4 reduces E₃ to E₄ with E₄=650(0.867/15.6)^{0.4}=204.6 Btu, which is rejected from the cylinder through an opened exhaust valve without being transformed into useful work done W. For this example, the indicated fuel conversion efficiency (IFCE) is equal 1−E₄/E₃.=1−204.6 Btu/650 Btu=0.685.

For the purposes of this discussion, the foregoing example will be referenced as the designed first-step combustion process for purposes of presenting a DSCP, as well as a CI-DSCP below.

The Second-Step CE Combustion Process

To meet required torque/power requirements above the level provided by the first step combustion process, a second step combustion process under CE begins at state (650 Btu, 0.867 ft³). By design, the second-step CE combustion process will provide additional power while ensuring that NOx formation will not take place during the second-step CE combustion process. The amount of fuel injection at each interval of the increase in the combustion chamber volume required to obtain the CE combustion process is computed by using the same equation of state E₂/E₁=(V₁,V₂)^{k-1} (and as shown in Table 1 below).

TABLE 1

| | 1 | 2 | 3 | 4 | 5 | 6 | 7 |
|---|---|---|---|---|---|---|---|
| 1 | V_{3b} (ft³) | 0.867 | 0.956 | 1.054 | 1.162 | 1.282 | 1.413 |
| 2 | Re | 18.0 | 16.3 | 14.8 | 13.4 | 12.2 | 11.0 |
| 3 | Q_{3b} (Btu) | 0 | 24.6 | 49.2 | 73.8 | 98.4 | 123.0 |
| 4 | E_{3b} (Btu) | 650 | 650 | 650 | 650 | 650 | 650 |
| 5 | Row 3 + E₃ₐ | 650 | 674.9 | 699.2 | 723.8 | 748.4 | 773.0 |
| 6 | E₄ (Btu) | 204.6 | 220.9 | 238.3 | 255.6 | 274.0 | 293.2 |
| 7 | IFCE | 0.685 | 0.673 | 0.659 | 0.647 | 0.634 | 0.620 |

Table 1 presents selected data for a representative DSCP. Column 2 represents the end of the first-step combustion process, whereas Columns 3-7 depict the second-step CE combustion process. Row 1 “V_{3b}” is the combustion chamber volume. The chamber volume at state (650 Btu, 0.867 ft³), the end of the first-step combustion process, is 0.867 ft³. To achieve the second-step CE combustion process to meet additional loading requirements, five loading increments corresponding to five chamber volumes (as chamber volume expands) are created by multiplying the volume of 0.867 ft³ (at the end of the first-step combustion process) by a chosen constant to produce a specified number of loading intervals (which are defined by volume rather than crank angle). In Table 1, a constant of 1.1027 has been chosen, which results in a first loading increment volume of 0.956 ft³ as set forth in Column 3. The remaining four loading increment volumes in Row 1 (Columns 4-7) are computed utilizing the selected constant.

Row 2 “Re” is the corresponding expansion ratio for the given process, i.e., the first-step combustion process or loading increment of the second-step CE combustion processes. Row 3 “Q_{3b}” presents the five required increments of heat addition. Row 4 “E_{3b}” is equal to E₃ₐ. Row 5 “Row 4+E₃ₐ” is the total E input equal to the value of E₃ₐ plus the corresponding Q value in Row 3. Row 6 “E₄” is the amount of E_{3b} not transformed into work done W. Row 7 “IFCE” is equal to (1—Row 6/Row 5).

It should be noted that at each state (columns 3-7), the condition “pV/E=2.396” is met demonstrating that this example satisfies the first law of thermodynamics. In addition, at every state, the combustion temperature is equal to E/cᵥ from which combustion pressure is computed. The combustion temperature does not exceed 2112.0° K at the end of the first-step combustion process and remains constant during the second-step CE combustion process to avoid the formation of NOₓ throughout the DSCP. Since the combustion pressure reaches equilibrium at the speed of molecules, all properties of the cylinder gases also reach equilibrium. To suggest otherwise, would mean that energy was either being created or destroyed in violation of the first law of thermodynamics.

A New CI-DSCP RICE

The creation of a new compression-ignition DSCP provides a platform for the development/creation of a new compression ignition reciprocating internal combustion engine operating on the DSCP. As previously mentioned the first-step combustion process of the new engine is designed to meet specified performance criteria and sized accordingly. Importantly, the first-step combustion process is designed subject to the condition that combustion temperatures remain below the threshold temperature at which NOx formation occurs. The second CE combustion process is available to meet performance requirements not readily met by the first-step combustion process. As discussed above, CE combustion ensures that combustion temperatures remain below the threshold temperature at which NOx formation takes place.

In the example discussed above, the first-step combustion process will end at state (650 Btu, 0.867 ft³). Further, the example shows a potential IFCE of 0.685 for the first-step combustion step. The second-step CE combustion process provides the capability to meet the full range of operating/loading requirements, while continuing to operate cleanly with minimal engine out emissions. In the example set for above, IFCE during the second-step CE combustion process remains above 0.620. Accordingly, the IFCE of the new engine is very high throughout the full operating range.

Emissions

As set forth above, the CI-DSCP RICE will be largely emissions-free on an engine out basis. Specifically, compression temperatures will be sufficiently high to ensure complete burning of all combustible products. Moreover, the low quantities of fuel added at any time, together with the longer combustion periods further assure complete burning. In addition, the engine will operate NO_{R}-free because combustion temperatures will be kept below the threshold at which NO formation occurs throughout DSCP. While it would be very difficult, if not impossible, to attempt to control combustion temperatures directly, the equation of state E₂/E₁=(V₁,V₂)^{k-1} allows the “E” at any given state to be readily calculated. As further stated above, since E=cᵥT, or T=E/cᵥ, the temperature at any given state (as defined by E and V) can also be readily calculated (and therefore controlled by limiting the amount of heat addition Q).

There apparently is a school of thought that the rate of heat addition cannot be controlled by the rate of fuel injection so as to control combustion temperatures. A related school of thought is that locally higher combustion temperatures prevent controlling combustion temperatures to avoid NO formation through the rate of heat addition. Both schools of thought are misguided.

The numerical constant “pV/E” (=2.3955) is a mathematical expression of the conservation of energy law. For example, at the beginning of a compression stroke, p₁ and T₁ are uniform and E₁ is evenly distributed within the cylinder volume with p₁V₁/E₁=2.3955 (in order to satisfy the law of conservation of energy). To satisfy the law of conservation of energy, at state (E₂, V₂) (the end of the compression stroke), p₂V₂/E₂=2.3955; and p₂ is the same throughout the combustion chamber volume and E₂ is evenly distributed as well. Given that E=cᵥT, or T=E/cᵥ, since E₂ is evenly distributed, T₂ will be uniform as well. When heat addition “Q” (together with additional compression work done) changes state (E₂, V₂) to state (E₃ₐ, V₃ₐ), then p₃ₐV₃ₐ/E₃ₐ must equal 2.3955 to satisfy the law of conservation of energy. Therefore, p₃ₐ is the same throughout the combustion chamber volume, E₃ₐ is evenly distributed throughout the combustion chamber volume, T₃ₐ is also uniform and there cannot be any locally high temperatures that could produce NOₓ to form.

As shown above, the equation of state E₂/E₁=(V₁,V₂)^{k-1} provides the wherewithal to determine the amount of heat addition Q required to reach a given state (once again as defined by a given “E” and “V”), and which internal energy “E” at any given state corresponds to a specific combustion chamber temperature “T.” In the discussion above, it is shown that that at the state (650 Btu, 0.867 ft³) (the state at the end of a first-step combustion process), the combustion temperature will be 2112° K, which is below the threshold at which NOx formation occurs. So long as the amount of heat addition Q does not exceed the amount necessary to achieve the specified state (again defined by “E” and “V”), “E” at that state will not exceed that target/limiting “E” value and the corresponding combustion temperature “T” will be limited as well. Similarly, during a CE combustion process, the same equation of state allows the amount of heat addition “Q” at given/selected loading volume increments to be calculated so as to ensure that “E” and the corresponding “T” will not exceed 2112° K.

Additional Features

As previously mentioned, a CI-DSCP RICE is sized based on the first-step combustion process performance specifications with additional loading/performance requirements met by the second-step CE combustion process resulting in the opportunity for significant downsizing. In addition, as discussed above, the new CI-DSCP RICE is designed with the maximum thermal and mechanical stresses at state (650 Btu, 0.867 ft³) (i.e., the state at the end of the first-step combustion process) while achieving an IFCE of 0.685. In meeting higher loading requirements during the second-step CE combustion process, thermal stress will remain approximately constant, while mechanical stress will be reduced (relative to the thermal and mechanical stresses at state (650 Btu, 0.867 ft³)). More specifically, the new engine operates below the maximum pressure of 1797 psia and at a maximum combustion “E” corresponding to a temperature of 2112° K. Accordingly, the sum of friction and heat losses will be much smaller than friction and heat losses of existing gasoline and diesel engines at operating full load.

Brake Fuel Conversion Efficiency

During the DSCP of a CI-DSCP RICE, both cylinder gas mass “m” and the k of the products of combustion will vary from state (E₂, V₂) to state (E₃ₐ, V_{3b}). Accordingly, the brake fuel conversion efficiency (BFCE) of a CI-DSCP RICE would be difficult to compute theoretically. Given the high IFCE and other features/characteristics of the new engine, however, the BFCE of the new engine can reasonably be expected to be exceptionally high. Those features/characteristics include:
i. Significant down-sizing;
ii. Low heat and friction losses;
iii. The absence of the need to use exhaust gas recirculation (EGR) will reduce the internal energy “E” of the exhaust gas further increasing IFCE; and
iv. High compression ratio corresponding to a high expansion ratio which will reduce E₄, the internal energy of exhaust gas.

Methods for Retrofitting Existing Engines

A method is described herein for retrofitting an existing compression ignition reciprocating internal combustion engine to operate according to a dual-step combustion process. The method can include modifying a cylinder clearance volume of an existing compression-ignition reciprocating internal combustion engine to obtain a compression ratio of about 18. The method can include modifying a fuel delivery system of the existing compression-ignition reciprocating internal combustion engine to achieve a first-step combustion process and a second-step combustion process. The first-step combustion process can include delivering a first quantity of fuel to a combustion chamber of the existing engine prior to a piston reaching top dead center in a cylinder in which the piston is disposed, where the first quantity of fuel is sufficiently small to ensure that a combustion temperature achieved during the first-step combustion process does not exceed a threshold temperature at which NOₓ formation occurs. The second-step combustion process can include delivering a second quantity of fuel to the combustion chamber of the existing engine after the piston has reached top dead center in the engine cylinder, where the second quantity of fuel is delivered to the engine cylinder at a rate configured to achieve a constant combustion temperature during the second-step combustion process, and where the second quantity of fuel is sufficiently small to ensure that the constant combustion temperature achieved during the second-step combustion process does not exceed the threshold temperature at which NOₓ formation occurs. In one example, the existing compression-ignition reciprocating internal combustion engine can be a four-stroke engine. In another example, the existing compression-ignition reciprocating internal combustion engine can be a two-stroke engine. The engine can have any suitable expansion ratio, such as an expansion ratio of about 18 or an expansion ratio of greater than 18.

Example Methods for Operating a CI-DSCP RICE

A method for determining a heat addition needed to achieve a target/limiting combustion temperature of a working fluid in a thermodynamic cycle performed in a compression-ignition reciprocating internal combustion engine can include a plurality of steps. The method can include defining a first state of a thermodynamic cycle, where the first state is defined by a first internal energy E₁ and a first volume V₁ of a working fluid located in a cylinder of an engine. The method can include determining a second state of the thermodynamic cycle, wherein the second state is defined by a second internal energy E₂ and a second volume V₂ of the working fluid located in the cylinder of the engine, wherein an equation of state E₂/E₁=(V₁/V₂)^{k-1} is used to solve for E₂ when the first internal energy E₁, the first volume V₁, and the second volume V₂ are known. The method can include determining a third state of the thermodynamic cycle, where the third state is defined by a third internal energy E_{3Qless} and a third volume V₃ of the working fluid located in the cylinder of the engine, where an equation of state E_{3Qless}/E₂=(V₂/V₃)^{k-1} is used to solve for E_{3Qless} when the first internal energy E₁, the first volume V₁, the second internal energy E₂ and the second volume V₂ are known. The method can include determining a target/limiting internal energy E_{3Limiting}, where E_{3Limiting} corresponds to a selected target/limiting combustion temperature T₃ at the third state by solving E_{3Limiting}=cᵥT₃. The method can include determining the heat addition Q needed to reach the target/limiting internal energy E_{3Limiting} at the third state by solving Q=E_{3Limiting}−E_{3Qless}. Once Q has been calculated, the amount of fuel that must be delivered (e.g. injected) into the combustion chamber to produce the heat addition Q during the combustion process can be determined by dividing the heat addition Q by a lower heating value of the fuel being used. To avoid NO_{R} formation, the target combustion temperature T₃ can be below a threshold temperature at which NOₓ formation occurs. In one example, the target combustion temperature T₃ can be below about 2,400 degrees F.

From the second state to the third state, the change in internal energy is attributable to both compression work W done on the system and heat Q added to the system. At the third state, E_{3Qless} represents the third internal E₃ without the heat addition Q. In other words, E_{3Qless} represents the change in internal energy due solely to compression work done on the system. E_{3Limiting} represents E₃ as calculated to be the internal energy of the target/limiting combustion temperature T₃ at the third state. The target/limiting combustion temperature is the maximum allowable temperature that can be achieved in the combustion chamber without producing NOₓ. The heat addition Q needed to achieve the target/limiting temperature T₃ is determined by calculating the difference between E_{3Limiting} and E_{3Qless} (i.e. Q=E_{3Limiting}−E_{3Qless}).

The thermodynamic cycle can include a compression process between the first state and the second state, a heat addition process between the second state and the third state, an expansion process between the third state and a fourth state, and a heat rejection process between the fourth state and the first state. In some examples, the thermodynamic cycle can include a second heat addition step during the expansion process between the second third and fourth states. The second heat addition can be a second-step combustion process. The second-step combustion process can include a single continuous injection of fuel during the expansion stroke or a plurality of smaller injections of fuel during the expansion stroke. The fuel can be delivered at a rate suitable to maintain a constant internal energy during the expansion stroke as work is done by the system. During the second-step combustion process, the internal energy (E_{second-step}) can be maintained at an internal energy that is equal to the target/limiting internal energy E_{3Limiting} achieved during the first-step combustion process, thereby maximizing the amount of work that can be output by the engine without producing NOₓ emissions.

Example Methods for Operating a CI-DSCP RICE

A method for determining a heat addition needed to achieve constant internal energy E in a second-step combustion process of a dual-step combustion process of a thermodynamic cycle performed in a compression-ignition reciprocating internal combustion engine can include a plurality of steps. Beginning with a third state of a first step combustion process, where the third state is defined by a target/limiting internal energy E_{3Limited} and a third volume V₃ of a working fluid located in a cylinder of an engine. The expansion stroke of the thermodynamic cycle can be subdivided into increments that correspond to cylinder volumes. For instance, V₃ᵢ represents a cylinder volume at a first expansion increment state, and V₃ᵢᵢ represents a cylinder volume at a second expansion increment state that occurs after V₃ᵢ in time during the expansion stroke of the cycle. At each increment of the expansion stroke, the state variables of the working fluid can be determined by applying the equations set forth in this application.

The method can include determining a first expansion increment state of the second step constant internal energy process (i.e. the second-step combustion process), where the first expansion increment state is defined by a first expansion increment internal energy E₃ᵢ and a first expansion increment volume V₃ᵢ of the working fluid located in the cylinder of the engine, where an equation of state E₃ᵢ/E_{3Limited}=(V₃ᵢ/V₃)^{k-1} is used to solve for E_{3iQLess} when the third internal energy E_{3Limited} and the third volume V₃ are known. E_{3iQLess} represents the internal energy at the first expansion increment state of the second-step constant internal energy process not accounting for the heat added. The method can include determining a heat addition Q₁ needed to reach the target/limiting E_{3Limiting} at the first expansion increment state of the second step constant internal energy E process by solving Qᵢ=E_{3Limiting}−E_{3iQless}. The method can include determining a second expansion increment state of the second step constant internal energy E process, wherein the second expansion increment state is defined by a second expansion increment internal energy E₃ᵢᵢ and a second expansion increment volume V₃ᵢᵢ of the working fluid located in the cylinder of the engine, where an equation of state E₃ᵢᵢ/E₃ᵢ=(V₃ᵢᵢ/V₃ᵢ)^{k-1} is used to solve for E_{3iiQLess} when the first expansion increment internal energy E₃ᵢ, the first expansion increment volume V₃ᵢ are known. The method can include determining the heat addition Qᵢᵢ needed to reach the target/limiting E_{3Limiting} at the second expansion increment state of the second step constant internal energy E process by solving Qᵢᵢ=E_{3Limiting}−E_{iiQless} and determining the amount of heat addition required for each ensuing additional increment of expansion beyond the second increment.

Example Methods for Operating a CI-DSCP RICE

A compression-ignition reciprocating internal combustion engine operating according to a dual-step combustion process can include a first-step combustion process and a second-step combustion process. The first-step combustion process can include delivering a first quantity of fuel to a combustion chamber of the engine prior to a piston reaching top dead center in a cylinder in which the piston is disposed, where the first quantity of fuel is determined based on selected design criteria including an engine loading requirement and a target/limiting combustion temperature T₃ to ensure that the target/limiting combustion temperature T₃ achieved during the first-step combustion process does not exceed a threshold combustion temperature at which NOₓ formation occurs. The second-step combustion process can include delivering a second quantity of fuel to the combustion chamber of the engine after the piston has reached top dead center in the engine cylinder, where the second quantity of fuel is delivered to the engine cylinder during an expansion stroke at predetermined increments of expanding cylinder volume at a rate configured to achieve a constant internal energy E_{second-step} during the second-step combustion process, where the constant internal energy E_{second-step} achieved during the second-step combustion process is equal to the target/limiting internal energy E_{3Limited} of a third state of the first-step combustion process corresponding to a target/limiting temperature T₃ of the working fluid within the cylinder, where the target/limiting temperature T₃ does not exceed the threshold combustion temperature at which NOₓ formation occurs. The compression-ignition reciprocating internal combustion engine can have a compression ratio between about 16 and 20 and an expansion ratio between about 16 and 20. In some examples, the compression-ignition reciprocating internal combustion engine can be a four-stroke engine, and in other examples the compression-ignition reciprocating internal combustion engine can be a two-stroke engine.

What is claimed is:

1. A method for determining a heat addition needed to achieve a target/limiting combustion temperature of a working fluid in a thermodynamic cycle performed in a compression-ignition reciprocating internal combustion engine, the method comprising:
defining a first state of a thermodynamic cycle, wherein the first state is defined by a first internal energy E₁ and a first volume V₁ of a working fluid located in a cylinder of an engine;
determining a second state of the thermodynamic cycle, wherein the second state is defined by a second internal energy E₂ and a second volume V₂ of the working fluid located in the cylinder of the engine, wherein an equation of state E₂/E₁=(V₁/V₂)^{k-1} is used to solve for E₂ when the first internal energy E₁, the first volume V₁, and the second volume V₂ are known;
determining a third state of the thermodynamic cycle, wherein the third state is defined by a third internal energy E_{3Qless} and a third volume V₃ of the working fluid located in the cylinder of the engine, wherein an equation of state E_{3Qless}/E₂=(V₂/V₃)^{k-1} is used to solve for E_{3Qless} when the first internal energy E₁, the first volume V₁, the second internal energy E₂ and the second volume V₂ are known;
determining a target/limiting internal energy E_{3Limiting}, wherein E_{3Limiting} corresponds to a selected target/limiting combustion temperature T₃ at the third state by solving E_{3Limiting}=CᵥT₃; and
determining the heat addition Q needed to reach the target/limiting internal energy E_{3Limiting} at the third state by solving Q=E_{3Limiting}−E_{3Qless}.

2. The method of claim 1, wherein the target combustion temperature T₃ is below a threshold temperature at which NOₓ formation occurs.

3. The method of claim 1, wherein the target combustion temperature T₃ is below about 2,400 degrees F.

4. The method of claim 1, wherein the thermodynamic cycle comprises a compression process between the first state and the second state.

5. The method of claim 4, wherein the thermodynamic cycle comprises a heat addition process between the second state and the third state.

6. The method of claim 5, wherein the thermodynamic cycle comprises an expansion process between the third state and a fourth state.

7. The method of claim 6, wherein the thermodynamic cycle comprises a heat rejection process between the fourth state and the first state.

8. A compression-ignition reciprocating internal combustion engine operating according to a dual-step combustion process, the process comprising:
a first-step combustion process comprising delivering a first quantity of fuel to a combustion chamber of the engine prior to a piston reaching top dead center in a cylinder in which the piston is disposed, wherein the first quantity of fuel is determined based on selected design criteria comprising an engine loading requirement and a target/limiting combustion temperature to ensure that the target/limiting combustion temperature achieved during the first-step combustion process does not exceed a threshold combustion temperature at which NOₓ formation occurs; and
a second-step combustion process comprising delivering a second quantity of fuel to the combustion chamber of the engine after the piston has reached top dead center in the engine cylinder, wherein the second quantity of fuel is delivered to the engine cylinder during an expansion stroke at predetermined increments of expanding cylinder volume at a rate configured to achieve a constant internal energy E_{second-step} during the second-step combustion process, wherein the constant internal energy E_{second-step} achieved during the second-step combustion process is equal to the target/limiting internal energy E_{3Limited} of a third state of the first-step combustion process corresponding to a target/limiting temperature T₃ of the working fluid within the cylinder, wherein the target/limiting temperature T₃ does not exceed the threshold combustion temperature at which NOₓ formation occurs.

9. The compression-ignition reciprocating internal combustion engine of claim 8, wherein the engine has a compression ratio between about 16 and 20.

10. The compression-ignition reciprocating internal combustion engine of claim 8, wherein the engine has an expansion ratio between about 16 and 20.

11. The compression-ignition reciprocating internal combustion engine of claim 8, wherein the engine is a four-stroke engine.

12. The compression-ignition reciprocating internal combustion engine of claim 8, wherein the engine is a two-stroke engine.

13. A method for retrofitting an existing compression ignition reciprocating internal combustion engine to operate according to a dual-step combustion process, the method comprising:
modifying a cylinder clearance volume of an existing compression-ignition reciprocating internal combustion engine to obtain a compression ratio of about 18;
modifying a fuel delivery system of the existing compression-ignition reciprocating internal combustion engine to achieve:
a first-step combustion process comprising delivering a first quantity of fuel to a combustion chamber of the existing engine prior to a piston reaching top dead center in a cylinder in which the piston is disposed, wherein the first quantity of fuel is sufficiently small to ensure that a combustion temperature achieved during the first-step combustion process does not exceed a threshold temperature at which NOₓ formation occurs; and
a second-step combustion process comprising delivering a second quantity of fuel to the combustion chamber of the existing engine after the piston has reached top dead center in the engine cylinder, wherein the second quantity of fuel is delivered to the engine cylinder at a rate configured to achieve a constant combustion temperature during the second-step combustion process, and wherein the second quantity of fuel is sufficiently small to ensure that the constant combustion temperature achieved during the second-step combustion process does not exceed the threshold temperature at which NOₓ formation occurs.

14. The method of claim 13, wherein the first quantity of fuel is determined by:
defining a first state of a thermodynamic cycle, wherein the first state is defined by a first internal energy E₁ and a first volume V₁ of a working fluid located in a cylinder of the existing engine;
determining a second state of the thermodynamic cycle, wherein the second state is defined by a second internal energy E₂ and a second volume V₂ of the working fluid located in the cylinder of the existing engine, wherein an equation of state E₂/E₁=(V₁/V₂)^{k-1} is used to solve for E₂ when the first internal energy E₁, the first volume V₁, and the second volume V₂ are known;
determining a third state of the thermodynamic cycle, wherein the third state is defined by a third internal energy E_{3Qless} and a third volume V₃ of the working fluid located in the cylinder of the existing engine, wherein an equation of state E_{3Qless}/E₂=(V₂/V₃)^{k-1} is used to solve for E_{3Qless} when the first internal energy E₁, the first volume V₁, the second internal energy E₂ and the second volume V₂ are known;
determining a target/limiting internal energy E_{3Limiting}, wherein E_{3Limiting} corresponds to a selected target/limiting combustion temperature T₃ at the third state by solving E_{3Limiting}=cᵥT₃; a
determining the heat addition Q needed to reach the target/limiting internal energy E_{3Limiting} at the third state by solving Q=E_{3Limiting}−E_{3Qless}; and
determining the first quantity of fuel by dividing the heat addition Q by a lower heating value of the fuel.

15. The method of claim 13, wherein the existing compression-ignition reciprocating internal combustion engine is a four-stroke engine.

16. The method of claim 13, wherein the existing compression-ignition reciprocating internal combustion engine is a two-stroke engine.

17. The method of claim 13, wherein the existing compression-ignition reciprocating internal combustion engine has an expansion ratio of about 18.

18. The method of claim 13, wherein the existing compression-ignition reciprocating internal combustion engine has an expansion ratio greater than 18.
